(19) United States
(12) Patent Application Publication
(10) Pub. No.: US 2023/0340281 A1
(43) Pub. Date: Oct. 26, 2023

(54) NANOTUBE DISPERSION, NANOTUBE FILM USING THE NANOTUBE DISPERSION AND MANUFACTURING METHOD THEREOF

(71) Applicant: KOREA INSTITUTE OF SCIENCE AND TECHNOLOGY, Seoul (KR)

(72) Inventors: Sang seok LEE, Jeollabuk-do (KR); Dong Su LEE, Jeollabuk-do (KR); Se Gyu JANG, Jeollabuk-do (KR); Yongho JOO, Jeollabuk-do (KR); Sukang BAE, Jeollabuk-do (KR); Seokhoon AHN, Jeollabuk-do (KR); Dae-Young JEON, Jeollabuk-do (KR); Jangyup SON, Jeollabuk-do (KR); Jungwon KIM, Jeollabuk-do (KR)

(21) Appl. No.: 17/956,980

(22) Filed: Sep. 30, 2022

(30) Foreign Application Priority Data
Apr. 20, 2022 (KR) 10-2022-0048817

(51) Int. Cl. C09D 7/45; C01B 32/174; C01B 32/159; C01B 21/064; C09D 1/00; C09D 7/65

(52) U.S. Cl. CPC C09D 7/45; C01B 32/174; C01B 32/159; C01B 21/0648; C09D 1/00; C09D 7/65; C01B 2202/02; C01B 2202/28; C01P 2004/13; C01P 2006/22

(57) ABSTRACT

A nanotube dispersion, a nanotube film manufactured using the same, and a manufacturing method thereof are provided. The nanotube dispersion comprises a nanotube, a nanotube dispersant including at least one selected from a compound represented by a chemical formula 1 and a salt thereof, and a solvent including one selected from an organic solvent, water, and a mixture thereof.

### CROSS-REFERENCE TO RELATED APPLICATIONS

This application claims the benefit of the Korean Patent Application No. 10-2022-0048817 filed on Apr. 20, 2022, which is hereby incorporated by reference as if fully set forth herein.

### FIELD OF THE INVENTION

The present disclosure relates to a nanotube dispersion, a nanotube film manufactured using the same, and a manufacturing method thereof, and more particularly, to a nanotube dispersion comprised of a nanotube dispersant including at least one selected from a compound represented by a chemical formula 1 and a salt thereof, a nanotube, and a solvent.

### BACKGROUND

Nanotube has been spotlighted as a promising new material for its excellent mechanical strength, thermal, physical and electrical stability. In particular, carbon nanotube (CNT) may be applied to a variety of fields such as energy, environment, medicine, and fiber.

In order to apply the nanotube to fields such as polymer composites, high conductive composites, electromagnetic wave shielding materials, secondary battery materials, artificial muscles, tissues, machinery, biosensors, and drug delivery, the nanotubes should have excellent dispersibility.

However, since nanotubes are generally aggregated due to strong van der Waals force between nanotubes and low solvent-friendly properties, a problem occurs in that dispersibility is not excellent in an organic solvent or a solvent such as water.

Regarding a method of dispersing nanotubes, a method of dispersing nanotubes in a superacid material such as chlorosulfonic acid has been conventionally known. However, there is a problem that the superacid material such as chlorosulfonic acid explosively reacts with moisture in the air and thus it is difficult to handle the superacid material.

As another method of dispersing nanotubes, there is a method of dispersing nanotubes by using a surfactant such as sodium dodecyl sulfate (SDS), but a problem occurs in that dispersibility is degraded at a high concentration.

In this respect, it is required to develop a nanotube dispersant ant and a nanotube dispersion including the same, which can improve water dispersibility of nanotubes while overcoming the above problems.

### SUMMARY

The present disclosure has been made in view of the above problems, and it is an object of the present disclosure to provide a nanotube dispersion having excellent water dispersibility of nanotube.

It is another object of the present disclosure to provide a nanotube film manufactured using a nanotube dispersion that is water dispersed.

It is other object of the present disclosure to provide a manufacturing method of a nanotube film using a nanotube dispersion that is water dispersed.

In addition to the objects of the present disclosure as mentioned above, additional objects and features of the present disclosure will be clearly understood by those skilled in the art from the following description of the present disclosure.

In accordance with an aspect of the present disclosure, the above and other objects can be accomplished by the provision of a nanotube dispersion comprising a nanotube, a nanotube dispersant including at least one selected from a compound represented by a chemical formula 1 below and a salt thereof, and a solvent including one selected from an organic solvent, water, and a mixture thereof:

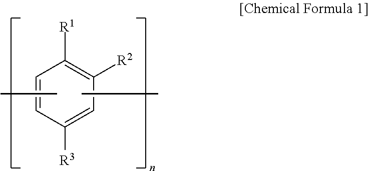

in the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

Each of the first hydrophilic substituent and the second hydrophilic substituent may be any one selected from a group consisting of a sulfo group (—SO₃H), a carboxyl group (—CO₂H), an amino group (—NH₂), an aldehyde group (—CHO), a hydroxyl group (—OH), and a nitro group (—NO₂).

The nanotube may include at least one selected from a group consisting of a single-walled carbon nanotube, a double-walled carbon nanotube, a multi-walled carbon nanotube, a bundle-type carbon nanotube, and a boron nitride nanotube (BNNT).

The nanotube may include 0.0001 to 30 parts by weight and the nanotube dispersant may include 0.0005 parts by weight or more, with respect to 100 parts by weight of the solvent.

In accordance with another aspect of the present disclosure, the above and other objects can be accomplished by the provision of a nanotube film comprising a nanotube, and a nanotube dispersant including at least one selected from a compound represented by a chemical formula 1 below and a salt thereof:

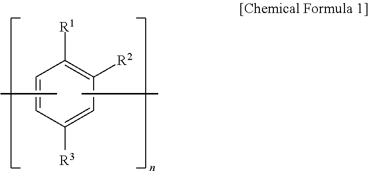

in the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

Each of the first hydrophilic substituent and the second hydrophilic substituent may be any one selected from a group consisting of a sulfo group (—SO₃H), a carboxyl group (—CO₂H), an amino group (—NH₂), an aldehyde group (—CHO), a hydroxyl group (—OH), and a nitro group (—NO₂).

In accordance with other aspect of the present disclosure, the above and other objects can be accomplished by the provision of a manufacturing method of a nanotube film, the manufacturing method comprising at least one of coating the nanotube dispersion on a substrate, vacuum-filtering the nanotube dispersion, or drying the nanotube dispersion.

### BRIEF DESCRIPTION OF THE DRAWINGS

The above and other objects, features and other advantages of the present disclosure will be more clearly understood from the following detailed description taken in conjunction with the accompanying drawings. In the drawings:

FIG. 1 illustrates a structure in which a nanotube dispersant is bonded to a surface of a nanotube;

“A” of FIG. 2 illustrates a photograph and an optical microscope photograph of a water dispersion of a nanotube including a nanotube dispersant;

“B” of FIG. 2 illustrates a photograph and an optical microscope photograph of a water dispersion of a nanotube that does not include a nanotube dispersant;

FIG. 3 is a photograph illustrating that a specimen of 20 μm manufactured using a dispersant manufactured by allowing a concentration of the dispersant to be different from a concentration of SWCNT is taken using an optical microscope and a polarizing microscope;

FIG. 4 is a photograph illustrating that a specimen of 20 μm manufactured using a dispersant containing a policresulen salt is taken using an optical microscope and a polarizing microscope;

“A” and “B” of FIG. 5 are photographs illustrating that a specimen of 20 μm manufactured using mechanical dispersion containing policresulen as a dispersant is taken using an optical microscope and a polarizing microscope;

“C” (right) of FIG. 5 is a photograph illustrating that a dispersion of Embodiment 3 is centrifuged and a dispersion from which a nanotube bundle is removed is taken using a polarizing microscope;

FIG. 6 is a photograph illustrating that nanotube films manufactured in Embodiments 5-1 to 5-3 are taken using a polarizing microscope;

FIG. 7 is a photograph illustrating that a nanotube film is taken using a scanning electron microscope; and

FIG. 8 is a photograph illustrating that a liquid crystal behavior according to a BNNT concentration is taken using an optical microscope and a polarizing microscope.

### DETAILED DESCRIPTION OF THE DISCLOSURE

Hereinafter, the embodiments of the present disclosure will be described in detail with reference to the accompanying drawings. The following embodiments are provided as an example so that spirits of the present disclosure may be sufficiently transferred to those skilled in the art. Therefore, the present disclosure is not limited to the embodiments described below and may be embodied in other forms.

Shapes, sizes, ratios, angles, and numbers disclosed in the drawings for describing embodiments of the present disclosure are merely examples, and thus the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In the case in which “comprise,” “have,” and “include” described in the present specification are used, another part may also be present unless “only” is used. The terms in a singular form may include plural forms unless noted to the contrary. In construing an element, the element is construed as including an error region although there is no explicit description thereof.

In describing a position relationship, for example, when the position relationship is described as ‘upon˜’, ‘above˜’, ‘below˜’, and ‘next to˜’, one or more portions may be arranged between two other portions unless ‘just’ or ‘direct’ is used.

Spatially relative terms such as “below”, “beneath”, “lower”, “above”, and “upper” may be used herein to easily describe a relationship of one element or elements to another element or elements as illustrated in the figures. It will be understood that these terms are intended to encompass different orientations of the device in addition to the orientation depicted in the figures. For example, if the device illustrated in the figure is reversed, the device described to be arranged “below”, or “beneath” another device may be arranged “above” another device. Therefore, an exemplary term “below or beneath” may include “below or beneath” and “above” orientations. Likewise, an exemplary term “above” or “on” may include “above” and “below or beneath” orientations.

In describing a temporal relationship, for example, when the temporal order is described as “after,” “subsequent,” “next,” and “before,” a case which is not continuous may be included, unless “just” or “direct” is used.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

It should be understood that the term “at least one” includes all combinations related with any one item. For example, “at least one among a first element, a second element and a third element” may include all combinations of two or more elements selected from the first, second and third elements as well as each element of the first, second and third elements.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in a co-dependent relationship.

One embodiment of the present disclosure provides a nanotube dispersion. The nanotube dispersion according to one embodiment of the present disclosure includes a nanotube, a nanotube dispersant including at least one selected from a compound represented by a chemical formula 1 below and a salt thereof, and a solvent including one selected from an organic solvent, water, and a mixture thereof.

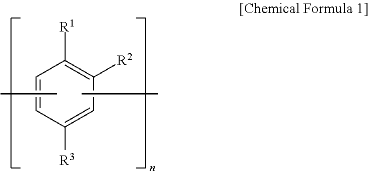

In the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

According to one embodiment of the present disclosure, the nanotube may include a carbon nanotube and a non-organic nanotube. According to one embodiment of the present disclosure, the nanotube may include at least one selected from a group consisting of a single-walled carbon nanotube, a double-walled carbon nanotube, a multi-walled carbon nanotube, a bundle-type carbon nanotube, and a boron nitride nanotube (BNNT), but the present disclosure is not limited thereto. The nanotube of the present disclosure may be defined as being more expanded than the concept of generally understood and commercially available nanotubes.

According to one embodiment of the present disclosure, a solvent of the nanotube dispersion may be preferably water.

According to one embodiment of the present disclosure, the nanotube dispersant of the present disclosure includes at least one selected from a compound represented by the following chemical formula 1 and a salt thereof.

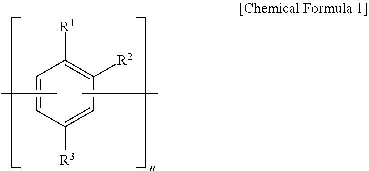

In the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

In the structure of the chemical formula 1, n may be preferably 2 to 6, and more preferably, n may be 3.

According to one embodiment of the present disclosure, in the structure of the chemical formula 1, R¹ is a para position from R³.

In the structure of the chemical formula 1, R¹ is a first hydrophilic substituent. The first hydrophilic substituent is hydrophilic, and may be also electronegative. The first hydrophilic substituent may prevent and stabilize aggregation of the nanotubes, thereby improving water dispersibility of the nanotubes.

According to one embodiment of the present disclosure, the first hydrophilic substituent may be any one selected from a group consisting of a sulfo group (—SO₃H), a carboxyl group (—CO₂H), an amino group (—NH₂), an aldehyde group (—CHO), a hydroxyl group (—OH), and a nitro group (—NO₂). According to one embodiment of the present disclosure, the first hydrophilic substituent may be preferably a sulfo group (—SO₃H).

According to one embodiment of the present disclosure, the first hydrophilic substituent may include a form of a salt of substituents of the group. A cation (X⁺) capable of forming the first hydrophilic substituent and the salt may be an atomic cation of an atomic group consisting of H, Al, Ba, Ca, Cr, Cu, Fe, Li, Mg, Mn, Ni, K, Na, Ti and Zn, or a molecular cation of a molecular group consisting of NH₄⁺, H₃O⁺, NO₂⁺, and the like. For example, the first hydrophilic substituent may be a salt form of a sulfo group (—SO₃⁻+X⁺).

According to one embodiment of the present disclosure, the first hydrophilic substituent may be a sulfo group (—SO₃H) or a salt form thereof (—SO₃⁻+X⁺).

In the structure of the chemical formula 1, R² is hydrogen (H) or a second hydrophilic substituent. When hydrophilicity of R¹ is sufficient to disperse the nanotubes, R² may be hydrogen (H), or R² may be a second hydrophilic substituent to further enhance water dispersibility of the nanotubes. When R² is a second hydrophilic substituent, water dispersibility of the nanotubes may be more improved by assisting the first hydrophilic substituent.

According to one embodiment of the present disclosure, the second hydrophilic substituent may be any one selected from a group consisting of a sulfo group (—SO₃H), a carboxyl group (—CO₂H), an amino group (—NH₂), an aldehyde group (—CHO), a hydroxyl group (—OH), and a nitro group (—NO₂). The second hydrophilic substituent may be the same as or different from the first hydrophilic substituent. According to one embodiment of the present disclosure, the second hydrophilic substituent may be preferably a hydroxyl group (—OH).

According to one embodiment of the present disclosure, the second hydrophilic substituent may include a form of a salt of the substituents of the group. The cation (X⁺) capable of forming the second hydrophilic substituent and the salt may be an atomic cation of an atomic group consisting of H, Al, Ba, Ca, Cr, Cu, Fe, Li, Mg, Mn, Ni, K, Na, Ti and Zn, or a molecular cation of a molecular group consisting of NH₄⁺, H₃O⁺, NO₂⁺, and the like. For example, the second hydrophilic substituent may be a salt form of a hydroxyl group (—O⁻+X⁺).

According to one embodiment of the present disclosure, the second hydrophilic substituent may be a hydroxyl group (—OH) or a salt form thereof (—O⁻+X⁺).

In the structure of the chemical formula 1, R³ is hydrogen (H) or an alkyl group having carbons of 1 to 20 (C1 to C20). According to one embodiment of the present disclosure, the alkyl group of R³ may include a linear, diverged or cyclic alkyl group.

In the structure of the chemical formula 1, R³ is a hydrophobic substituent. R³ serves to provide hydrophobicity to a compound represented by the chemical formula 1. The nanotube dispersant represented by the chemical formula 1 may be bonded to a hydrophobic surface of the nanotube by π-π interaction through the hydrophobic substituent R³ and a benzene ring portion.

According to one embodiment of the present disclosure, the nanotube dispersant may be a policresulen. The policresulen is represented by the following chemical formula 2.

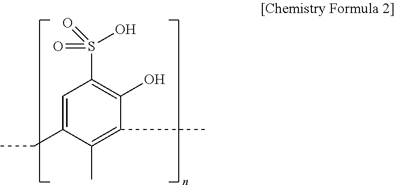

The nanotube dispersant including at least one selected from a compound represented by the chemical formula 1 and a salt thereof according to one embodiment of the present disclosure includes a first hydrophilic substituent R¹ and/or a second hydrophilic substituent R² and a hydrophobic substituent R³, thereby effectively improving water dispersibility of the nanotubes with a small amount.

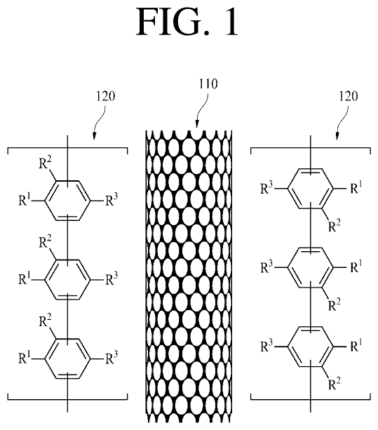

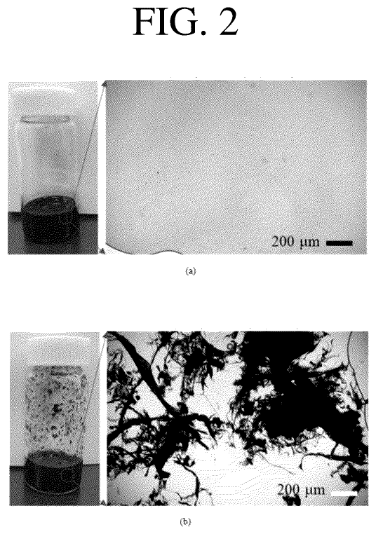

The nanotube dispersion effect of the nanotube dispersant according to one embodiment of the present disclosure will be described in more detail with reference to FIG. 1.

FIG. 1 illustrates a structure in which a nanotube dispersant 120 is bonded to a surface of a nanotube 110.

As illustrated in FIG. 1, the nanotube dispersant 120 may be bonded to the surface of the nanotube 110. In detail, the nanotube dispersant 120 represented by the chemical formula 1 may be bonded to a hydrophobic surface of the nanotube 110 by π-π interaction through the hydrophobic substituent R³ and the benzene ring portion. When the nanotube dispersant 120 is bonded to the hydrophobic surface of the nanotube 110 by the hydrophobic substituent R³ and the benzene ring portion, the first hydrophilic substituent R¹ is disposed on an opposite surface of the bonded surface of the nanotube dispersant 120 and the nanotube 110. The first hydrophilic substituent R¹ positioned to be opposite to the hydrophobic substituent R³ portion generates a repulsive force against another nanotube 110, and the nanotubes 110 may be dispersed together by the repulsive force. As a result, the nanotubes 110 may be prevented from being aggregated and may be stabilized, so that water dispersibility of the nanotubes 110 may be improved.

According to one embodiment of the present disclosure, the nanotube dispersion may include a nanotube of 0.0001 to 30 parts by weight and a nanotube dispersant of 0.0005 parts by weight or more with respect to 100 parts by weight of a solvent.

When the nanotube dispersion includes a nanotube less than 0.0001 parts by weight with respect to parts by weight of the solvent, electrical conductivity of the dispersion is reduced, and the solvent is unnecessarily increased, which is disadvantageous in the process. On the contrary, when the nanotube dispersion include a nanotube more than 30 parts by weight with respect to 100 parts by weight of the solvent, dispersibility may be deteriorated due to high viscosity.

When the nanotube dispersion includes a nanotube dispersant less than 0.0005 parts by weight with respect to 100 parts by weight of the solvent, a problem may occur in that the nanotubes are not sufficiently dispersed. An upper limit of a content of the nanotube dispersant is not particularly limited. Meanwhile, the content of the nanotube dispersant may be determined based on the nanotubes.

According to one embodiment of the present disclosure, the nanotube dispersion may include a nanotube dispersant of 5 to 1500 parts by weight with respect to 100 parts by weight of the nanotube.

When the nanotube dispersion includes a nanotube dispersant less than 5 parts by weight with respect to 100 parts by weight, a problem may occur in that the nanotube is not sufficiently dispersed. On the contrary, even though the nanotube dispersion includes a nanotube dispersant more than 1500 parts by weight with respect to 100 parts by weight, there is no significant difference in effect of improving dispersibility of the nanotube, and thus it is disadvantageous in view of process and cost, but the present disclosure is not limited thereto. For example, the content of the nanotube dispersant may be adjusted by a type and surface area of the nanotube. For example, a preferred content ratio of the nanotube and the nanotube dispersant may vary depending on whether the nanotube is a single-walled carbon nanotube or a multi-walled carbon nanotube. In more detail, when a multi-walled BNNT is used, sufficient dispersibility may be obtained even though a small amount of a dispersant relative to a weight of BNNT is used as compared with a case that a single-walled carbon nanotube is used. Hereinafter, a nanotube film according to another embodiment of the present disclosure will be described.

Another embodiment of the present disclosure provides a nanotube film. According to another embodiment of the present disclosure, the nanotube film may include a transparent electrode film, a CNT Bucky paper, and the like.

The nanotube film according to another embodiment of the present disclosure includes a nanotube, and a nanotube dispersant including at least one selected from a compound represented by the chemical formula 1 and a salt thereof.

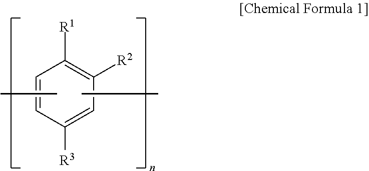

In the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

The nanotube and the nanotube dispersant represented by the chemical formula 1 according to another embodiment of the present disclosure are as described above. Therefore, a repeated description will be omitted.

According to another embodiment of the present disclosure, the nanotube film may include a nanotube dispersant of 0.0001 to 50 parts by weight with respect to 100 parts by weight of the nanotube film.

Unique physical properties such as electrical conductivity and mechanical properties of the nanotube are enhanced as the nanotube dispersant in the manufactured nanotube film is closer to 0 relative to 100 parts by weight of the nanotube. In contrast, as the ratio of the nanotube dispersant in the manufactured nanotube film is increased, a problem may occur in that electrical conductivity and mechanical properties of the nanotube film are deteriorated.

The nanotube film according to another embodiment of the present disclosure may be applied to fields such as a polymer composite, a highly conductive composite, an electromagnetic wave shielding material, a secondary battery material, an artificial muscle, a tissue, a machine, a biosensor, and drug delivery due to excellent dispersibility and electrical conductivity of the nanotube.

Hereinafter, a manufacturing method of a nanotube film according to another embodiment of the present disclosure will be described.

Another embodiment of the present disclosure provides a manufacturing method of a nanotube film. The manufacturing method of a nanotube film may include at least one of the steps of coating the aforementioned nanotube dispersion on a substrate, vacuum-filtering the nanotube dispersion and drying the nanotube dispersion.

In detail, the manufacturing method of a nanotube film may vary depending on a type of the nanotube film to be manufactured. For example, a manufacturing method of an arranged nanotube film and a manufacturing method of a nanotube film in the form of Bucky paper may be different from each other.

The manufacturing method of an arranged nanotube film may include the steps of coating the above-described nanotube dispersion on a substrate and drying the coated dispersion.

In the step of coating the nanotube dispersion on the substrate, the nanotube dispersion is as described above. Therefore, a repeated description will be omitted.

According to another embodiment of the present disclosure, the step of coating the nanotube dispersion on a substrate may be by a spray coating method, but the present disclosure is not limited thereto. The nanotube dispersant may be coated by other methods capable of coating a dispersion in addition to the spray coating method.

According to another embodiment of the present disclosure, the step of coating the nanotube dispersion on a substrate may be coated at a coating rate of 5 to 80 mm/sec. The coating rate may be coated at a constant rate of 5 to 80 mm/sec. In detail, for example, the nanotube dispersion may be coated on the substrate at a constant rate, such as a coating rate of 5 to 80 mm/sec, under an inert atmosphere.

According to another embodiment of the present disclosure, the manufacturing method of a nanotube film may further include the step of removing the nanotube dispersant. The step of removing the nanotube dispersant may be preferably performed after the step of drying the coated dispersion.

In detail, after drying the coated dispersion, the nanotube dispersant present in the nanotube film may be removed using an organic solvent. The organic solvent may be, for example, ethanol, but the present disclosure is not limited thereto.

According to another embodiment of the present disclosure, in the step of coating the nanotube dispersion on the substrate, there is no particular limitation in the type of the substrate. The substrate may be a glass substrate, an aluminum substrate, a stainless (SUS) substrate, a Teflon substrate, a PET substrate, a polyimide substrate, or the like. According to one embodiment of the present disclosure, a glass substrate may be used as the substrate.

The manufacturing method of a nanotube film in the form of Bucky paper may include at least one of the steps of vacuum-filtering the above-described nanotube dispersion and manufacturing a film by evaporating a solvent.

In the step of manufacturing the nanotube film in the form of Bucky paper, the nanotube dispersion is as described above. Therefore, a repeated description will be omitted.

According to another embodiment of the present disclosure, the manufacturing method of a nanotube film in the form of Bucky paper may further include the step of removing the nanotube dispersant. It is preferable that the step of removing the nanotube dispersant is performed after the step of drying the solvent.

In detail, after drying the nanotube film, the nanotube dispersant present in the nanotube film may be removed using an organic solvent. The organic solvent may be, for example, ethanol, but the present disclosure is not limited thereto.

According to another embodiment of the present disclosure, there is no particular limitation in a filter material for vacuum-filtering the nanotube dispersion. Preferably, a filter of a material, such as nylon, Polytetrafluoroethylene (PTFE), glass fiber, cellulose, and polyether sulfone (PES), which satisfies hydrophilic/hydrophobic properties of the solvent, may be used.

According to another embodiment of the present disclosure, in the step of manufacturing a nanotube film in the form of Bucky paper by drying, a method such as natural drying, heating drying, hot air drying, freeze-drying, vacuum drying, etc. may be used as the drying method, and there is no particular limitation in the drying method. Preferably, a uniform film may be manufactured by drying the nanotube film below a boiling point of the solvent. A container selected to dry the dispersion is not particularly limited to the type of the substrate. A material such as polyethylene (PE), silicon, glass, Teflon substrate, PET and polyimide may be used as the container. According to one embodiment of the present disclosure, a polyethylene (PE) material may be used as the container.

Hereinafter, the present disclosure will be described in more detail with reference to exemplary embodiments and comparative examples. However, the present disclosure is not limited by the embodiments and comparative examples, which are described below.

### Embodiment 1

The nanotube dispersion was performed for a case that policresulen was added and a case that policresulen was not added, to check dispersion performance of policresulen. A nanotube dispersion was manufactured by equally applying a bath-type ultrasonic disperser (JAC-3010, 40 kHz, 300 Watt-max) to a case that policresulen of a concentration of 10 wt % and single-walled carbon nanotube (SWCNT) of 2 mg/g are present in water and a case that only single-walled carbon nanotube (SWCNT) of 2 mg/g is present in water, for about 60 minutes. “A” (upper) of FIG. 2 illustrates a photograph and an optical microscope photograph of a nanotube dispersion in which single-walled carbon nanotube (SWCNT) of a concentration of 2 mg/g and policresulen of a concentration of 10 wt % are dispersed in a solvent (water), and “B” (lower) of FIG. 2 illustrates a photograph and an optical microscope photograph of a nanotube dispersion in which policresulen is not contained. As suggested in FIG. 2, in case of “B” (lower) in which policresulen is not contained, it is noted that a bundle is formed without dispersion of CNT as compared with “A” (left).

### Embodiment 2

After single-walled carbon nanotube (SWCNT) (Tuball 95% SWCNT, OCSiAl) and policresulen were mixed with each other in a solvent (water) at their respective concentrations different from each other, the mixed dispersion was dispersed by a bath-type ultrasonic disperser (JAC-3010, 40 khz, 300 Watt-max) for about 60 minutes to manufacture a nanotube dispersion. A specimen was manufactured by fixing a polyimide film having a thickness of 20 μm to both sides on a glass substrate using the manufactured dispersion, dropping about 10 μl of the nanotube dispersion between both sides, and covering a cover glass.

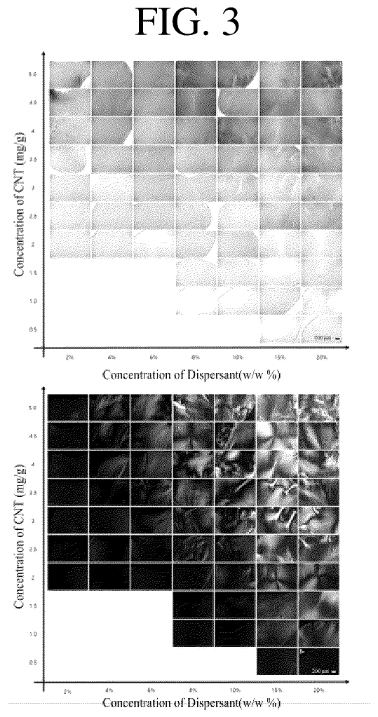

The dispersion degree of the SWCNT according to the concentration (x-axis) of the dispersant and the concentration (y-axis) of the SWCNT for the manufactured specimen was observed using an optical microscope and a polarizing microscope corresponding to the optical microscope. The observed optical microscope photograph and polarizing microscope photograph corresponding to the optical microscope photograph are as illustrated in FIG. 3.

FIG. 3 is a photograph illustrating that a specimen of 20 μm manufactured using a dispersant manufactured by allowing a concentration of the dispersant to be different from a concentration of SWCNT is taken using an optical microscope and a polarizing microscope. “A” (upper) of FIG. 3 is a photograph taken using an optical microscope, and “B” (lower) of FIG. 3 is a photograph taken using a polarizing microscope.

As illustrated in the optical microscope photograph “A” of FIG. 3, it is noted that large aggregates of a carbon nanotube are not observed in a micrometer scale so that the dispersion is well performed. In addition, as illustrated in the polarizing microscope photograph “B” of FIG. 3, it is noted that a bright portion and a dark portion are observed on the photograph of the specimen at a specific concentration or more and thus a CNT liquid crystal phase appears. This means that the dispersion of the carbon nanotube is well performed at a high concentration.

### Embodiment 3

After single-walled carbon nanotube (SWCNT) of a concentration of 2 mg/g and a policresulen salt (cation: Na⁺) of a concentration of 10 wt % were mixed with each other in a solvent (water), the mixed dispersion was dispersed by a bath-type ultrasonic disperser (JAC-3010, 40 khz, 300 Watt-max) for about 120 minutes to manufacture a nanotube dispersion. A specimen of Embodiment 3, which has a thickness of 20 μm, was manufactured using the manufactured dispersion in the same method as that of the Embodiment 2.

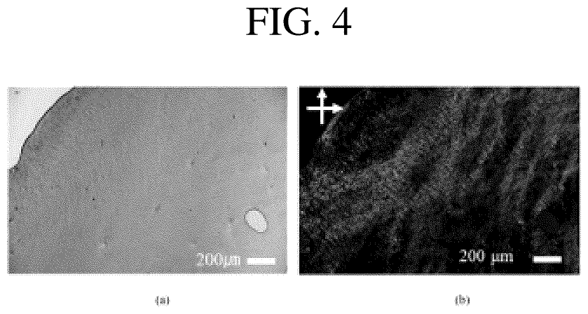

The dispersion degree of the manufactured specimen of the Embodiment 3 was observed using an optical microscope and a polarizing microscope corresponding to the optical microscope. The observed optical microscope photograph and polarizing microscope photograph corresponding to the optical microscope photograph are as illustrated in FIG. 4.

FIG. 4 is a photograph illustrating that a specimen of 20 μm manufactured using the dispersant of the Embodiment 3 is taken using an optical microscope and a polarizing microscope. “A” (left) of FIG. 4 is a photograph taken using an optical microscope, and “B” (right) of FIG. 4 is a photograph taken using a polarizing microscope.

As illustrated in FIG. 4, even when a policresulen salt not policresulen is used as a dispersant, it is noted that dispersibility of the nanotube is excellent.

### Embodiment 4

After single-walled carbon nanotube (SWCNT) of a concentration of 2 mg/g and policresulen of a concentration of 10 wt % were mixed with each other in a solvent (water), the mixed dispersion was stirred using a homomixer (HM1QT, K&S company) for about 60 minutes to manufacture a nanotube dispersion. A specimen of Embodiment 4, which has a thickness of 20 μm, was manufactured using the manufactured dispersion in the same method as that of the Embodiment 2.

The dispersion degree of the manufactured specimen of the Embodiment 4 was observed using an optical microscope and a polarizing microscope corresponding to the optical microscope. The observed optical microscope photograph and polarizing microscope photograph corresponding to the optical microscope photograph are as shown in “A” and “B” of FIG. 5.

“A” and “B” of FIG. 5 are photographs illustrating that a specimen having a thickness of 20 μm manufactured using the dispersion of the Embodiment 4 is taken using an optical microscope and a polarizing microscope. “A” (left) of FIG. 5 is a photograph taken using an optical microscope, and “B” (middle) of FIG. 5 is a photograph taken using a polarizing microscope.

As illustrated in “A” and “B” of FIG. 5, when policresulen is used as a dispersant, it is noted that dispersibility of the nanotube is excellent because large aggregates are not formed only by mechanical dispersion.

Also, the prepared dispersion was centrifuged (12000 RPM, 20 minutes) to manufacture a dispersion from which a nanotube bundle was removed.

The dispersion degree of the dispersant from which the nanotube bundle was removed was observed using a polarizing microscope. The observed optical microscope photograph and polarizing microscope photograph are as shown in “C” of FIG. 5.

“C” (right) of FIG. 5 is a photograph illustrating a dispersion obtained by centrifuging the dispersion of the Embodiment 4 and removing a nanotube bundle which finely remains, is taken using a polarizing microscope.

As shown in “C” of FIG. 5, when the nanotube bundle which finely remains in the dispersion manufactured by mechanical dispersion is removed from the dispersion through centrifugation, it is noted through a polarizing microscope photograph that a nanotube dispersion with more improved dispersion degree of the nanotube may be manufactured and a clear liquid crystal phase is formed.

### Embodiments 5-1 to 5-3

After single-walled carbon nanotube (95% SWCNT, OCSiAl company) and policresulen were mixed with each other in a solvent (water) at their respective concentrations different from each other, the mixed dispersion was dispersed by a bath-type ultrasonic disperser (JAC-3010, 40 khz, 300 Watt-max) for about 60 minutes to manufacture a nanotube dispersion.

A nanotube film in which nanotube was arranged in a coating direction was manufactured using the manufactured dispersion and varying a thickness of an applicator on a substrate through an automatic control coater. A glass substrate was used as the substrate, and the coating speed was uniformly maintained at 40 mm/s. The coated nanotube film was dried at 80° C. for 5 minutes, and the dried nanotube film was immersed in ethanol to remove policresulen. The nanotube film manufactured by varying the concentrations of SWCNT and policresulen and the thickness of the applicator was manufactured as in Embodiments 5-1 to 5-3, and a total of three nanotube films were manufactured.

The concentrations of SWCNT and policresulen and the thickness of the applicator in the Embodiments 5-1 to 5-3 are as illustrated in Table 1 below.

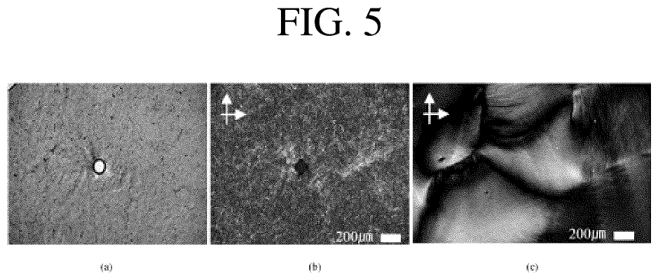

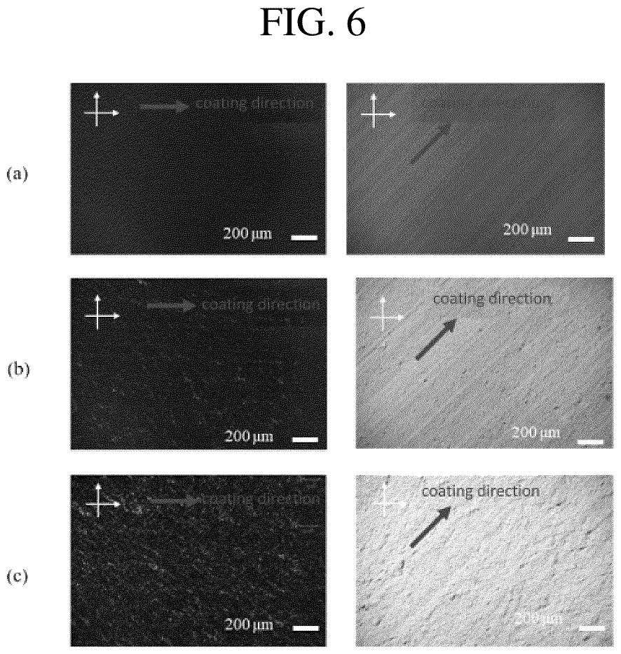

The nanotube films of Embodiments 5-1 to 5-3 manufactured as above were observed using a polarizing microscope. The observed polarizing microscope photograph is as illustrated in FIG. 6.

FIG. 6 is a photograph illustrating that the nanotube films manufactured in Embodiments 5-1 to 5-3 are taken using a polarizing microscope. “A” of FIG. 6 is a photograph illustrating the nanotube film of Embodiment 5-1 is taken, “B” of FIG. 6 is a photograph illustrating the nanotube film in Embodiment 5-2 is taken, and “C” of FIG. 6 is a photograph illustrating the nanotube film of Embodiment 5-3 is taken.

As illustrated in FIG. 6, it is noted that the nanotube film manufactured using a nanotube dispersion containing policresulen is arranged in a coating direction. In FIG. 6, the left photograph is a case that a coating direction is perpendicular to a test plate of the microscope, wherein a phase of linearly polarized horizontal light incident by the arranged nanotube film is not changed to allow the light not to be transmitted and thus the nanotube film is seen to be dark. The right photograph is a case that a coating direction and a test plate of the microscope form an angle of 45°, wherein a phase of linearly polarized horizontal light is changed by the nanotube film arranged at an angle of 45° and thus the nanotube film is seen to be bright through the test plate perpendicular thereto. This indicates that the nanotube is arranged in the coating direction of the film.

Also, transmittance of the manufactured nanotube film was measured at a wavelength of 560 nm by using a spectroscope (Black-comet, stellarNet), and sheet resistance of the film was measured by using a sheet resistance meter (ARMS-600, 4-point probe).

The transmittance and sheet resistance of the nanotube films of the Embodiments 5-1 to 5-3 are as illustrated in Table 1 below.

TABLE 1

| | SWCNT | Policresulen | Thickness | | Sheet |
|---|---|---|---|---|---|
| | concentration | concentration | of Applicator | Transmittance | resistance |
| Classification | (mg/g) | (wt %) | (μm) | (%) | (ohm/sq) |
| Embodiment | 4 | 4 | 2 | 90 | 610 |
| 5-1 | | | | | |
| Embodiment | 4 | 4 | 4.57 | 82 | 247 |
| 5-2 | | | | | |
| Embodiment | 6 | 6 | 11.4 | 50 | 50 |
| 5-3 | | | | | |

As illustrated in Table 1, it is noted that all of the nanotube films of the Embodiments 5-1 to 5-3, which were manufactured using the nanotube dispersion containing policresulen, have transmittance of 50% or more and have sheet resistance of 610 ohm/sq or less, and transmittance and sheet resistance may be controlled by controlling the coating thickness.

### Embodiments 6-1 to 6-3

A dispersion was manufactured by mixing single-walled carbon nanotube (95% SWCNT, OCSiAl company) of a concentration of 1 mg/g with policresulen of a concentration of 10 wt % in a solvent (water).

Nanotube films of Embodiments 6-1 to 6-3 were manufactured using the manufactured dispersant and different dispersion methods and different manufacturing methods. The manufactured nanotube films were immersed in ethanol to remove policresulen.

Detailed dispersion methods and manufacturing methods of the Embodiments 6-1 to 6-3 are as follows.

### (1) Embodiment 6-1

The mixed dispersion was stirred using a homomixer (HM1QT, K&S company) for about 60 minutes to manufacture a nanotube dispersion.

The nanotube film of the Embodiment 6-1 was manufactured by concentrating the dispersed nanotube dispersion by a vacuum pump using a PTFE filter having pores of 0.45 μm.

### (2) Embodiment 6-2

The mixed dispersion was stirred using a homomixer (HM1QT, K&S company) for about 60 minutes to manufacture a nanotube dispersion.

The dispersed nanotube dispersion was poured into a mold and dried at 40° C. to manufacture a nanotube film of Embodiment 6-2.

### (3) Embodiments 6-3

The mixed dispersion was dispersed by a bath-type ultrasonic disperser (JAC-3010, 40 kHz, 300 Watt-max) for about 60 minutes to manufacture a nanotube dispersion.

The nanotube film of the Embodiment 6-3 was manufactured by concentrating the dispersed nanotube dispersion by a vacuum pump using a PTFE filter having pores of 0.45 μm.

The following inspection was performed for the manufactured nanotube films of the Embodiments 6-1 to 6-3.

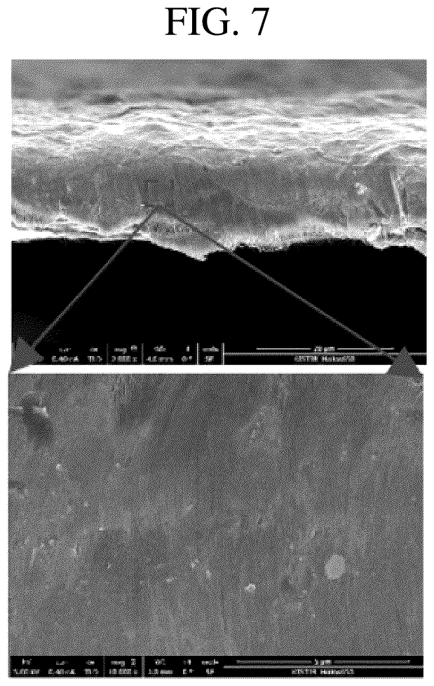

1) Scanning Electron Microscope: The nanotube film of Embodiment 6-1 was observed using a scanning electron microscope (Helios650). The observed scanning electron microscope photograph is as illustrated in FIG. 7. FIG. 7 is a photograph illustrating that a nanotube film is taken using a scanning electron microscope.

As illustrated in FIG. 7, it is noted that the nanotube films of the Embodiments 6-1 to 6-3 have highly integrated nanotubes.

2) Sheet resistance and electrical conductivity: Sheet resistance of the nanotube films of the Embodiments 6-1 to 6-3 was measured using a sheet resistance meter (ARMS-600, 4-point probe). In addition, electrical conductivity was derived through sheet resistance measurement. The sheet resistance and electrical conductivity of the nanotube films of the Embodiments 6-1 to 6-3 are as illustrated in Table 2.

[Table 2]

TABLE 2

| | | Method of | | | Sheet | electrical |
|---|---|---|---|---|---|---|
| | Dispersion | fabricating | Weight | Thickness | Resistance | conductivity |
| Classification | Method | film | (mg) | (μm) | (ohm/sq) | (S/cm) |
| Embodiment | Homomixer | Vacuum | 18.0 | 13.3 | 0.094 | 8.01E+03 |
| 6-1 | 1 Hour | Filtering | | | | |
| Embodiment | Homomixer | Mold | 24.1 | 10.1 | 0.115 | 8.67E+03 |
| 6-2 | 1 Hour | Dry | | | | |
| Embodiment | Bath Type | Vacuum | 25.3 | 12.5 | 0.203 | 3.96E+03 |
| 6-3 | Ultrasonic | Filtering | | | | |
| | Disperser | | | | | |
| | 1 Hour | | | | | |

As illustrated in Table 2, it is noted that the nanotube films of the Embodiments 6-1 to 6-3 have excellent sheet resistance values and electrical conductivity. In the Embodiment 6-3 in which a bath-type ultrasonic wave disperser is used, it is noted that electric conductivity is low because the SWCNT is partially cut by ultrasonic waves.

### Embodiment 7

After boron nitride nanotubes (BNNT) of 0.66 g and policresulen (70 wt %) of 26 g were mixed with each other in a solvent (water), the mixed dispersion was stirred using a Homomixer (T18, IKA) at about 11,000 RPM for 3 hours. Then, after water was added to the mixed dispersion, the concentration of the policresulen was diluted to 2.5 wt % and followed by centrifugation (4000 RPM, 5 minutes) to settle impurities, whereby the dispersed BNNT dispersion was obtained from the dispersed supernatant. The concentration of the BNNT of the supernatant was concentrated to adjust a weight ratio of the dispersant to the BNNT to 1:1, and a change of the BNNT dispersion according to the concentration was observed by a microscope while putting into or evaporating water.

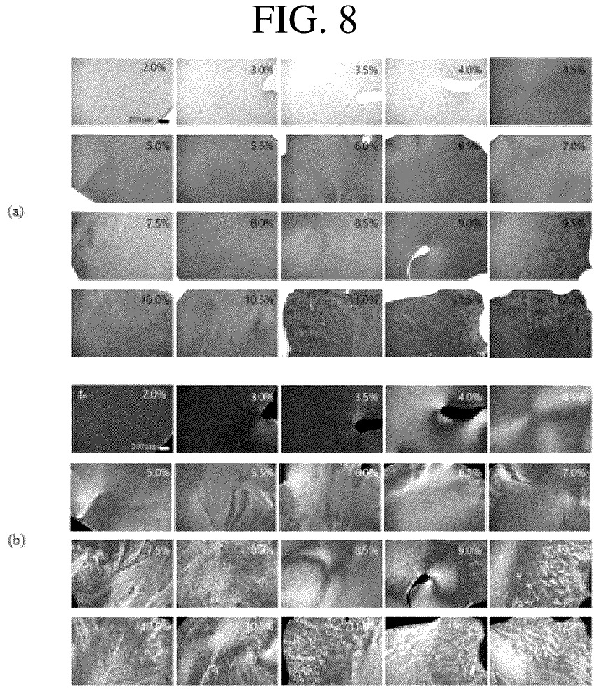

A specimen was manufactured by fixing a polyimide film having a thickness of 20 μm to both sides on a glass substrate using the manufactured dispersion, dropping about 10 μl of the nanotube dispersion between both sides, and covering a cover glass. A liquid crystal behavior according to the BNNT concentration was observed using an optical microscope and a polarizing microscope while concentrating the BNNT dispersion. An optical microscope photograph and a polarizing microscope photograph, which were observed with different BNNT concentrations, are as illustrated in FIG. 8.

FIG. 8 is a photograph illustrating that a liquid crystal behavior according to a BNNT concentration is taken using an optical microscope and a polarizing microscope. “A” of FIG. 8 is a photograph taken using an optical microscope, and “B” of FIG. 8 is a photograph taken using a polarizing microscope.

As illustrated in FIG. 8, it is noted that BNNT is dispersed without aggregation at all concentrations. In addition, it is noted that the liquid crystal of the BNNT is observed. Therefore, it is noted that the BNNT is well dispersed by policresulen.

According to the present disclosure, the following advantageous effects may be obtained.

According to the nanotube dispersion of the present disclosure, the nanotubes may have excellent dispersibility and dispersion stability even when the nanotube dispersion is highly concentrated in a solvent. Therefore, the nanotube dispersion of the present disclosure may be applied to various fields such as a vehicle field, a military field, a medical field, an exercise product, a secondary battery material, etc.

In addition, the nanotube may be uniformly arranged using the nanotube dispersion of the present disclosure, whereby the nanotube film having high light transmittance and low sheet resistance may be manufactured.

Also, the nanotube film in the form of Bucky paper, which has excellent electrical conductivity, may be manufactured by using the nanotube dispersion of the present disclosure.

It will be apparent to those skilled in the art that the present disclosure described above is not limited by the above-described embodiments and the accompanying drawings and that various substitutions, modifications, and variations can be made in the present disclosure without departing from the spirit or scope of the disclosures. Consequently, the scope of the present disclosure is defined by the accompanying claims, and it is intended that all variations or modifications derived from the meaning, scope, and equivalent concept of the claims fall within the scope of the present disclosure.

What is claimed is:

1. A nanotube dispersion comprising:
a nanotube;
a nanotube dispersant including at least one selected from a compound represented by a chemical formula 1 below and a salt thereof; and
a solvent including one selected from an organic solvent, water, and a mixture thereof: 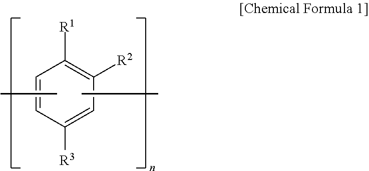
in the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

2. The nanotube dispersion of claim 1, wherein each of the first hydrophilic substituent and the second hydrophilic substituent is any one selected from a group consisting of a sulfo group (—SO₃H), a carboxyl group (—CO₂H), an amino group (—NH₂), an aldehyde group (—CHO), a hydroxyl group (—OH), and a nitro group (—NO₂).

3. The nanotube dispersion of claim 1, wherein the nanotube includes at least one selected from a group consisting of a single-walled carbon nanotube, a double-walled carbon nanotube, a multi-walled carbon nanotube, a bundle-type carbon nanotube, and a boron nitride nanotube (BNNT).

4. The nanotube dispersion of claim 1, wherein the nanotube includes 0.0001 to 30 parts by weight and the nanotube dispersant includes 0.0005 parts by weight or more with respect to 100 parts by weight of the solvent.

5. A nanotube film comprising:
a nanotube; and
a nanotube dispersant including at least one selected from a compound represented by a chemical formula 1 below and a salt thereof: 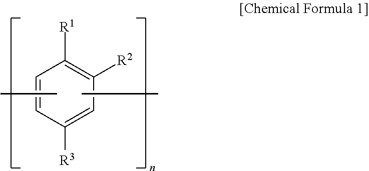
in the chemical formula 1, R¹ is a first hydrophilic substituent, R² is hydrogen (H) or a second hydrophilic substituent, R³ is hydrogen (H) or an alkyl group having carbons of 1 to 20 (C1 to C20), and n is an integer of 30 or less.

6. The nanotube dispersion of claim 5, wherein each of the first hydrophilic substituent and the second hydrophilic substituent is any one selected from a group consisting of a sulfo group (—SO₃H), a carboxyl group (—CO₂H), an amino group (—NH₂), an aldehyde group (—CHO), a hydroxyl group (—OH), and a nitro group (—NO₂).

7. A manufacturing method of a nanotube film, the manufacturing method comprising at least one of:
coating the nanotube dispersion of claim 1 on a substrate;
vacuum-filtering the nanotube dispersion; or
drying the nanotube dispersion.
